(19) United States
(12) Patent Application Publication
(10) Pub. No.: US 2018/0274651 A1
(43) Pub. Date: Sep. 27, 2018

(54) CHAINRING

(71) Applicant: Christianson Systems, Inc., Blomkest, MN (US)

(72) Inventors: Jim Gerhardt, St. Augusta, MN (US); Shannon Hansen, Bird Island, MN (US); Patrick Robert Jensen, South Haven, MN (US)

(21) Appl. No.: 15/470,281

(22) Filed: Mar. 27, 2017

(51) Int. Cl. F16H 55/30; B62M 9/00; B62M 3/00

(52) U.S. Cl. CPC F16H 55/30; B62M 3/00; B62M 9/00

(57) ABSTRACT

The present disclosure provides a new chainring system and method of installing and removing a chainring. The system eliminates the need for the use of special tools to install and remove a chainring.

### BACKGROUND

Chainrings are sprockets that are attached to a crank of a bicycle. As used herein, the term “sprocket” refers to a toothed gear or wheel used to connect to a chain or belt, and the term “crank” is used to refer to the level arm between the pedal and the bottom bracket. Some bicycles often include one, two, or three chainrings. In bicycles that include more than one chainring, the chainrings are stacked adjacent to each other with minimal lateral spacing there between to facilitate gear shifting. As chains are narrow the spacing between the adjacent chainrings is also decreases. From time to time, the chainrings are removed and replaced due to wear and/or to adjust the drive ratio of the bicycle. There is a need in the art for chainrings that can be placed closer to each other and can be removed and replaced easier.

### SUMMARY

The present disclosure provides a new chainring system and method of installing and removing a chainring. The system eliminates the need for the use of special tools to install and remove a chainring.

### BRIEF DESCRIPTION OF THE FIGURES

FIG. 1 is a front isometic view of an embodiment of the chainring according to principles of the present disclosure;

FIG. 2 is a rear isometric view of the chainring of FIG. 1;

FIG. 3 is a front view of the chainring of FIG. 1;

FIG. 4 is a rear view of the chainring of FIG. 1;

FIG. 5 is a side view of the chainring of FIG. 1;

FIG. 6 is an exploded assembly view of the chainring of FIG. 1;

FIG. 7 is a front isometic view of an alternative embodiment of the chainring according to principles of the present disclosure;

FIG. 8 is a rear isometric view of the chainring of FIG. 7;

FIG. 9 is a front view of the chainring of FIG. 7;

FIG. 10 is a rear view of the chainring of FIG. 7;

FIG. 11 is a side view of the chainring of FIG. 7; and

FIG. 12 is an exploded assembly view of the chainring of FIG. 7.

### DETAILED DESCRIPTION

Referring to the FIGS., generally the chainring of the present disclosure is described herein in further detail. In the depicted embodiment, the chainring assembly includes a ring shaped body 10 with a central through opening 12 and a plurality of tabs 14, 16, 18, 20, 22 that extend inwardly from a ring-shaped body portion 10. In the depicted embodiment, the body 10 includes a plurality of teeth 24 arranged about a periphery edge 26. In the depicted embodiment, the teeth 24 are configured to engage a chain and the periphery edge 26 of the chainring defines a circular shape. However, it should be appreciated that alternative embodiments exist. For example, the teeth could be configured to engage a belt and the chainring can be non-circular (e.g., oval). In the depicted embodiment, the chainring body is a machined piece of aluminum. However, it should be appreciated that many other constructions are also possible (forged alloys, carbon fiber composites, steel, etc.)

In the depicted embodiment, the chainring body 10 includes a first side 28 and an opposed second side 30. In the depicted embodiment, each tab 14, 16, 18, 20, 22 includes a locking recess 32 in the second side 30 that include a through aperture 34 that extend from the second side 30 to the first side 28 of the body 10. In the depicted embodiment, the aperture 34 in each of the tabs are located the same distance from a center point CP of the chainring body 10. In the depicted embodiment, each of the locking recesses 32 and through aperture 34 are identical. However, it should be appreciated that in alternative embodiment they aperture and recesses could have different configurations.

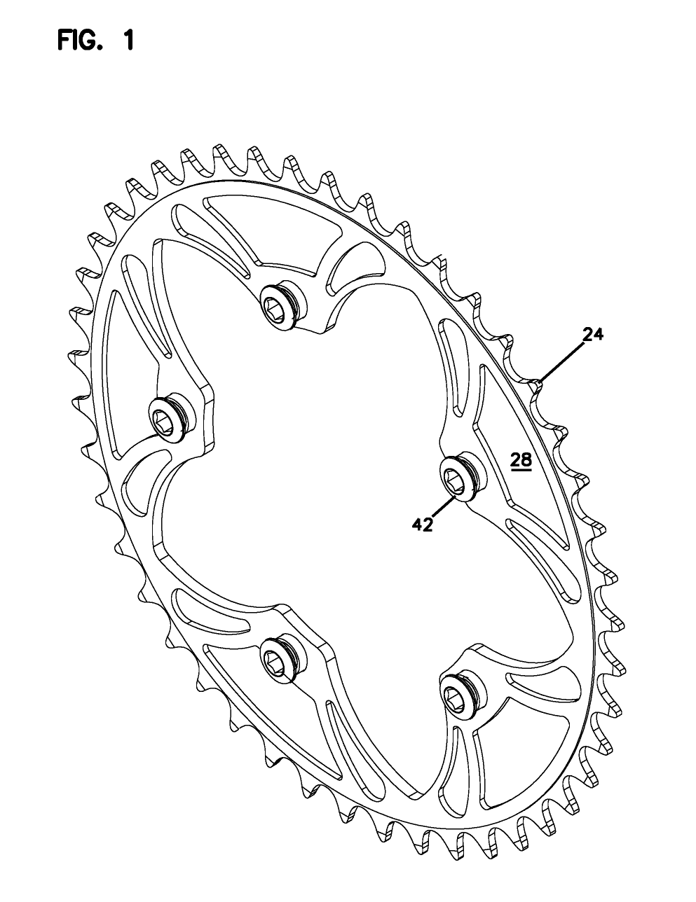

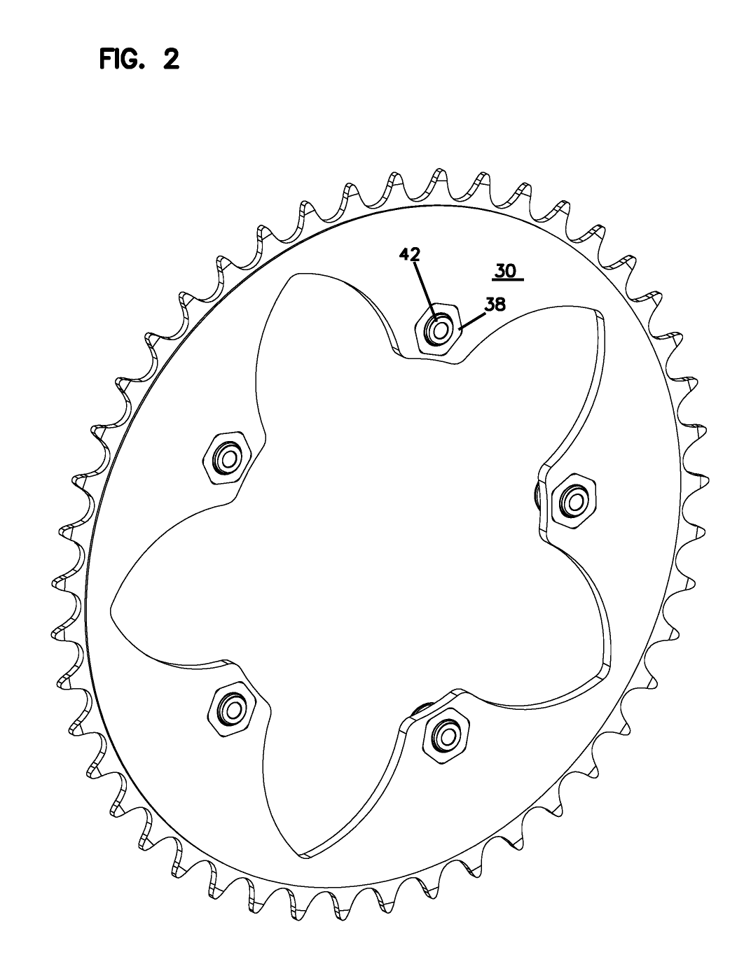

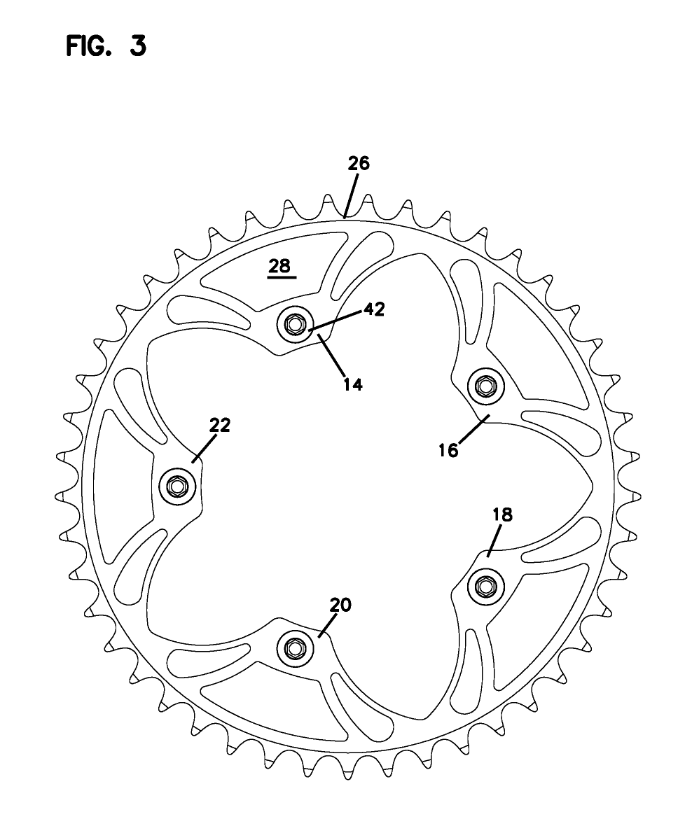

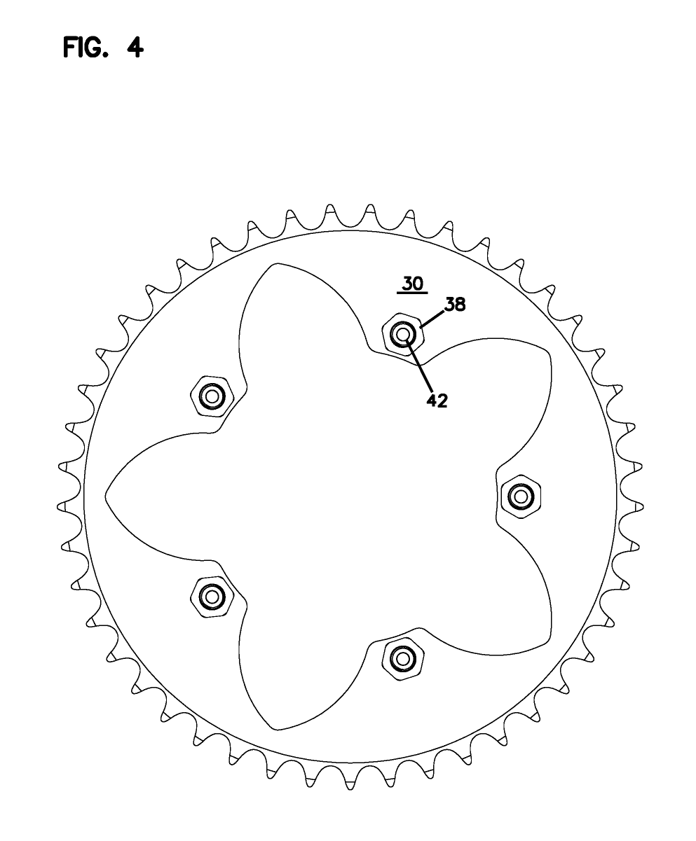

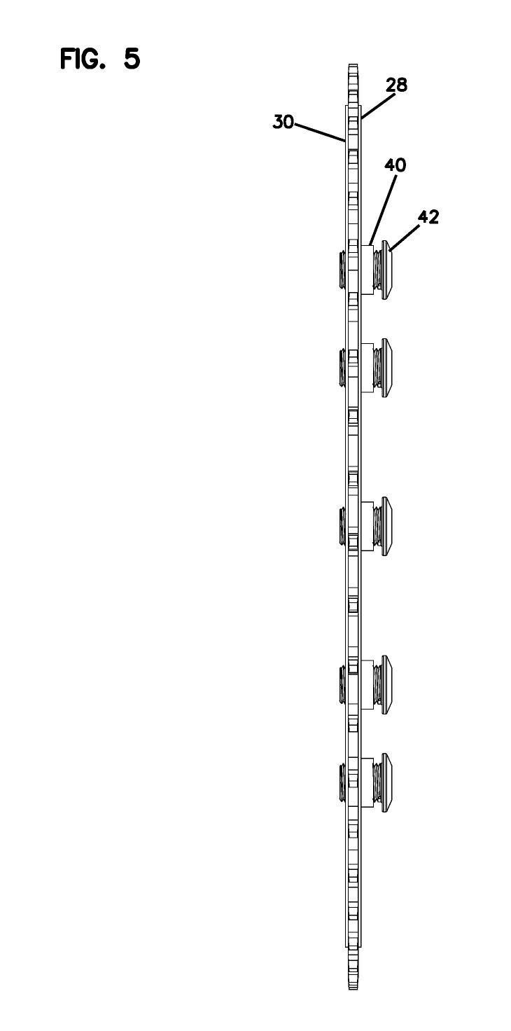

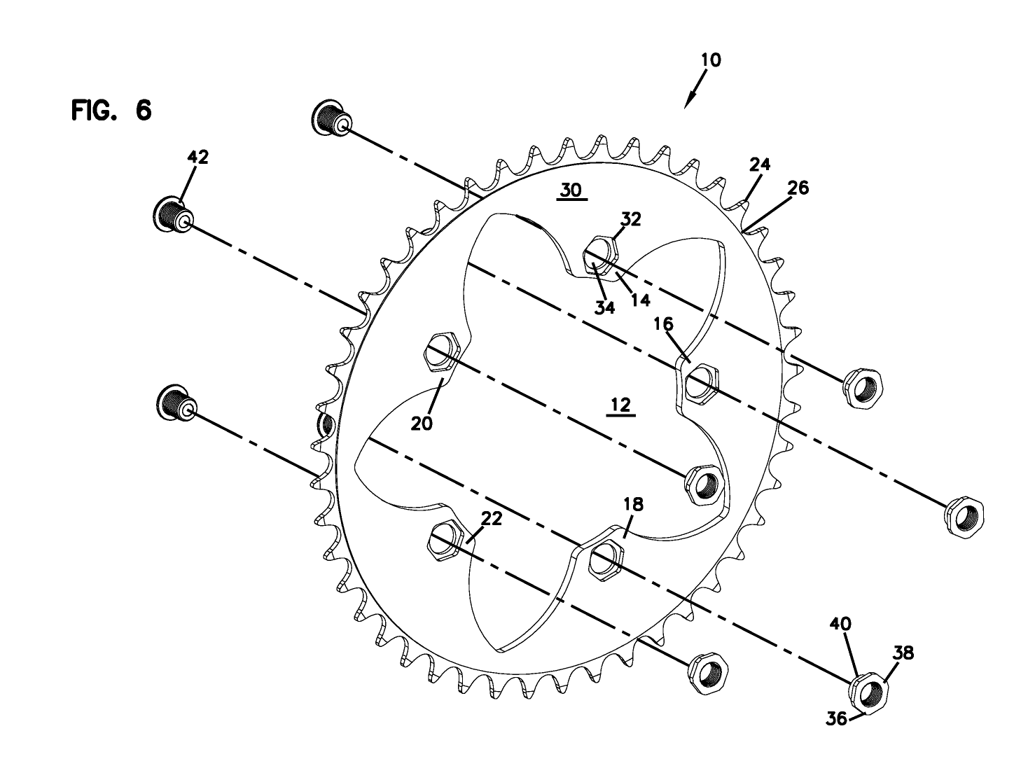

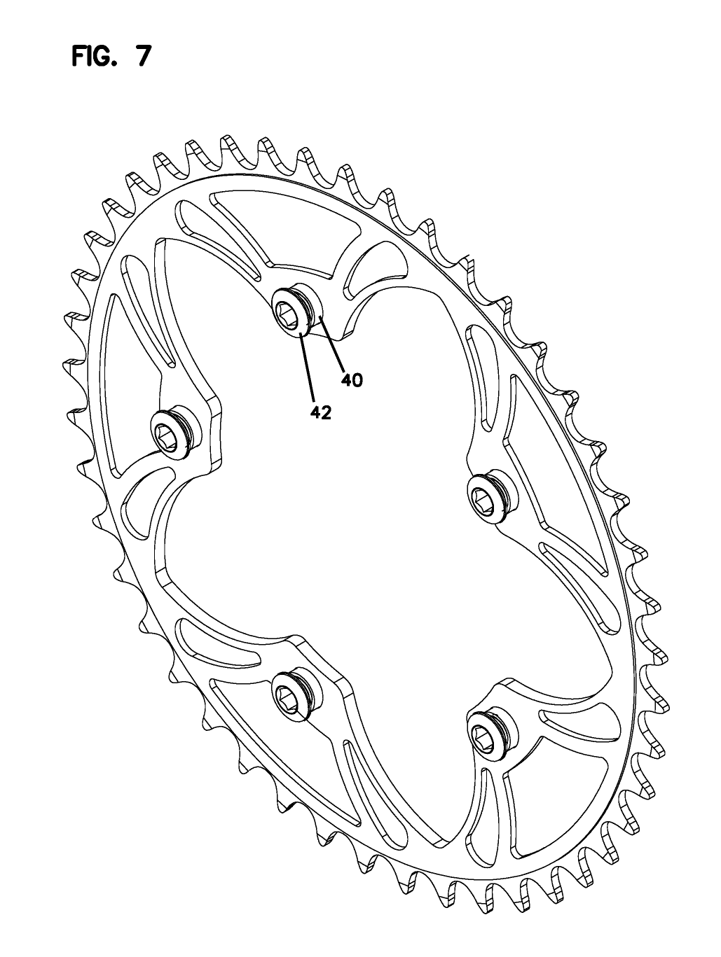

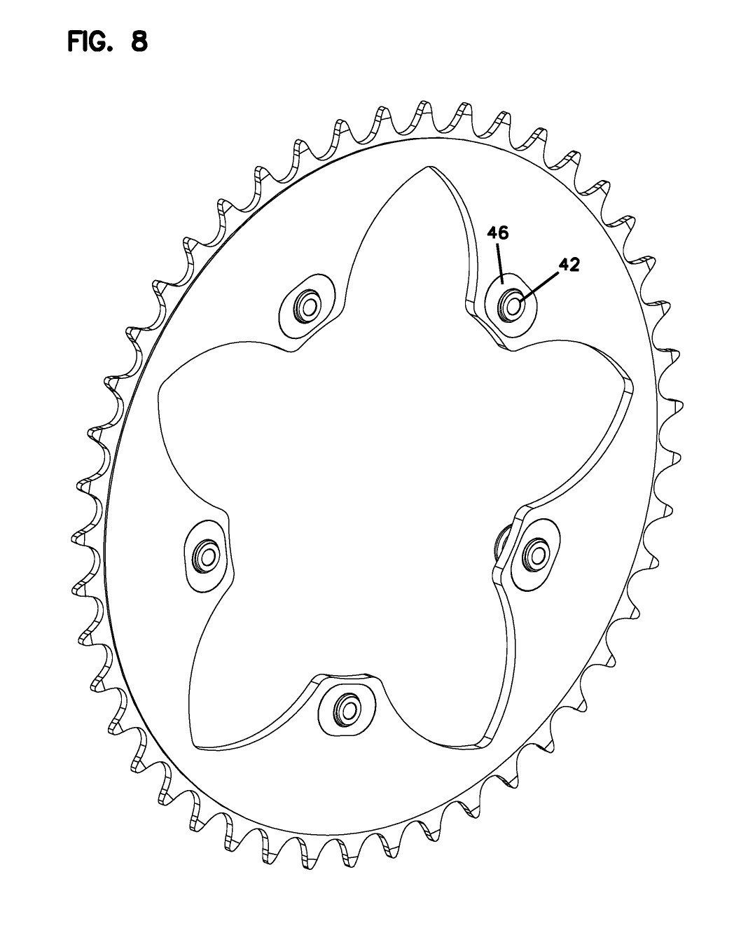

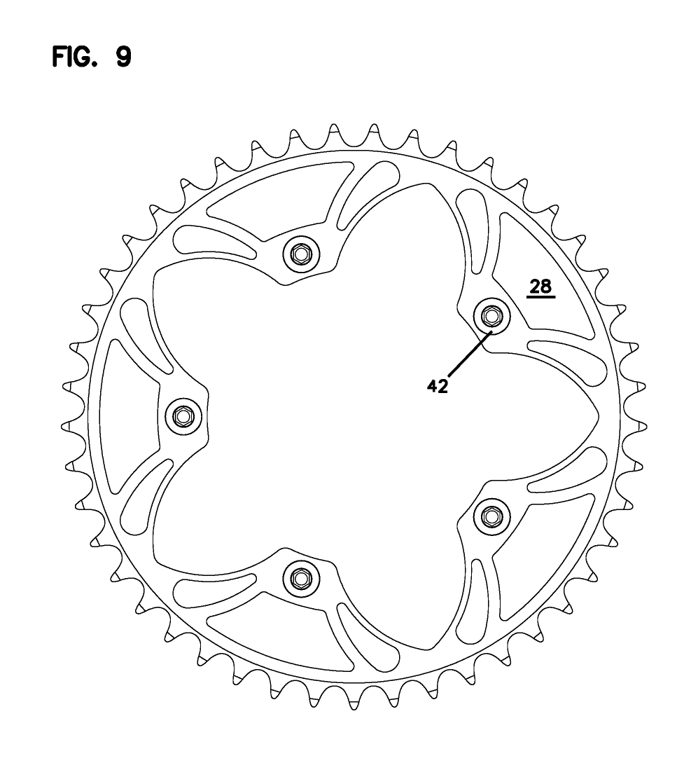

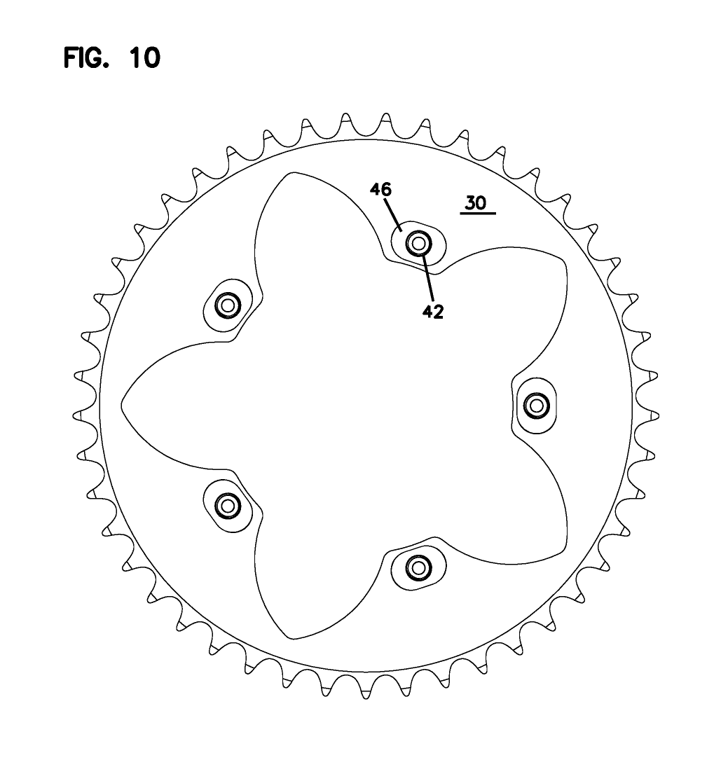

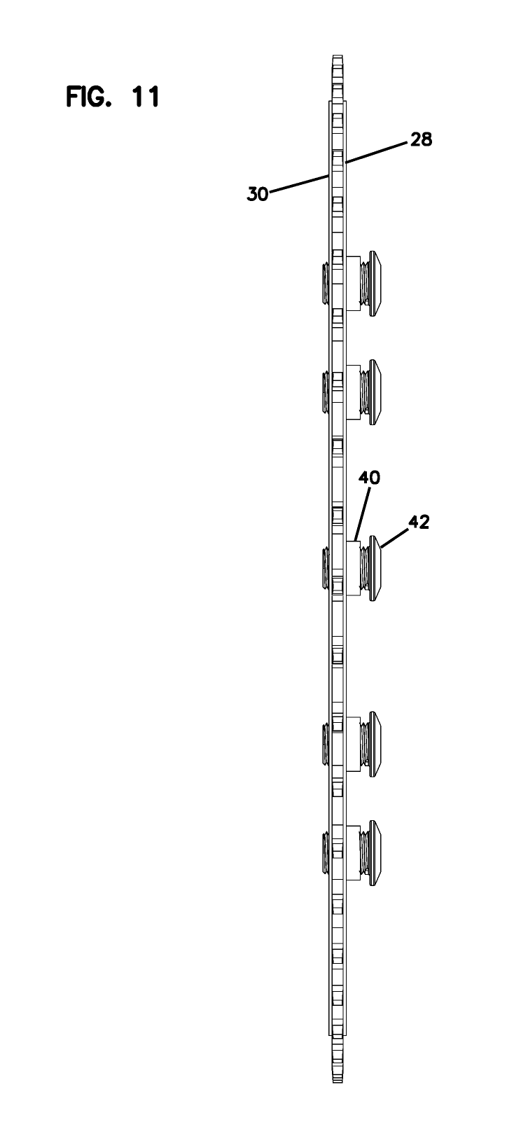

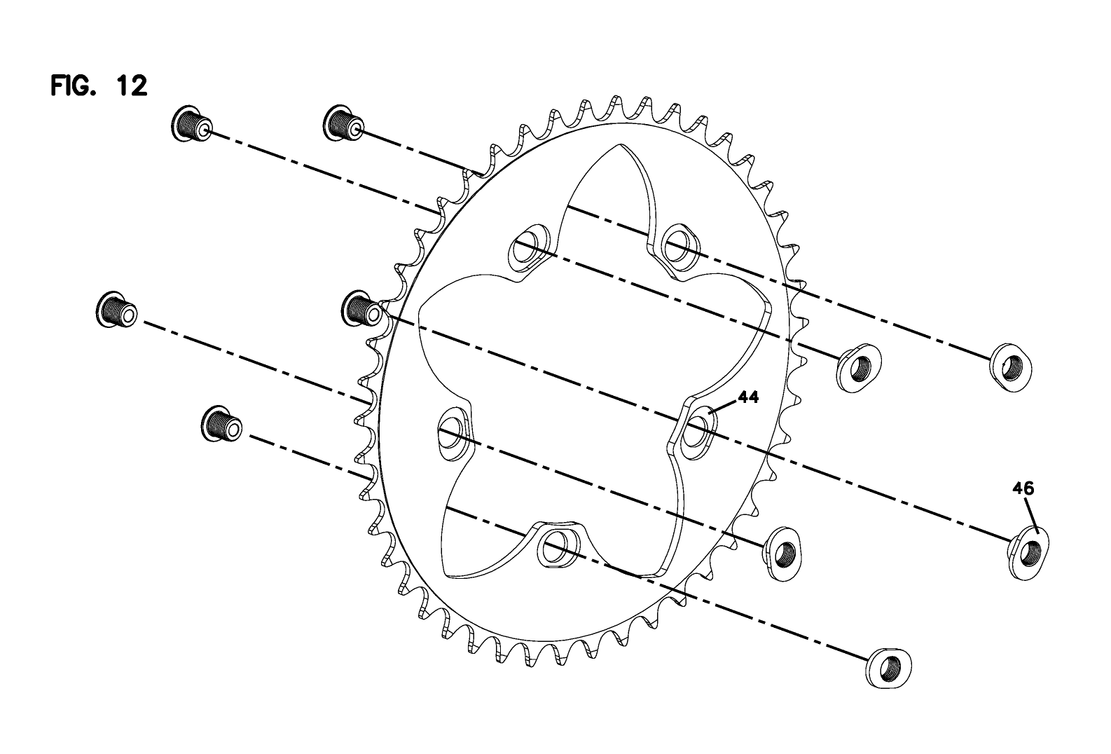

In the depicted embodiment, the locking recess 32 includes a non-circular periphery profile. For example the locking recess in FIGS. 1-6 is has a hexagon shape periphery that include flat sections (i.e., six flat section that are arranged in a hexagon shape). The locking recess 44 has an oval shape in the embodiment shown in FIGS. 7-12. In the depicted embodiments, the through apertures 34 are centered in the locking recesses and the through aperture 34 include a circular cross sectional profile. It should be appreciated that many other alternative configurations are also possible. For example, the through aperture could be off centered in the locking recess and the locking recess could have a circular periphery profile. Alternative, the through aperture could have a non-circular profile and locking recess could have a circular profile and be coaxially arranged (centered) with the aperture.

In the depicted embodiment, the assembly also includes an insert 36 that configured to be received within at least a portion of the locking recess 32 such that the rotation of the insert 36 relative to the chainring body 10 is constrained when the insert 36 is engaged with the locking recess 32. In the depicted embodiment, the rotational constraint is due to interference between the locking recess 32 and the flange 38 (e.g., interlocking engagement between the locking recess 32 and the flange 38). In the depicted embodiment, the flange 38, 46 has the same periphery shape as the locking recess. However, as discussed above the rotational constraint could alternatively be due to interference between other portions of the insert (e.g., the tube portion 40) and other portions of the chainring body (the aperture 34). As discussed above, in the depicted embodiment, the insert 36 includes a flange 38 configured to interlock with the locking recess 36 and a threaded tube portion 40 connected to the flange 38 that is configured to be received by the insert receiving aperture 34. In the depicted embodiment, the flange 38 has a thickness that is less than or equal to the depth of the locking recess (e.g, about 1-4 millimeters). In the depicted embodiment, the insert is formed of steel. It should be appreciated that many other construction are also possible (e.g., titanium, alloys, etc.).

In the depicted embodiment, the assembly also includes a faster 42 including a threaded portion that is configured to extend through the body 10 from the first side of the chainring body 10 and engage the threaded tube portion 40 of the insert 36.

The present disclosure also provides a new method of installing a chainring that includes the steps of engaging a flange of a threaded insert with a recess in the chain ring body; aligning the threaded insert with an aperture in a spider of a crank arm; inserting a threaded bolt through the aperture in the spider; and engaging the threads of the bolt with the thread of the threaded insert. In the depicted embodiment, the step of engaging the threads on the both with the threads of the threaded insert requires the use of only a single hex tool. In the depicted embodiment the insert with the flange establishes concentricity for the chainring to the spider when engaged with the threaded bolt. This method eliminates the need for a special tool to remove and install chainrings.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A chainring comprising:
a body include a plurality of teeth arranged about a periphery edge, wherein the body includes a first side and an opposed second side;
a locking recess located on the second side of the body;
a insert receiving aperture position in the locking recess that extend from the second side to the second side of the body; and
an insert configured to be received within at least a portion of the locking recess such that the rotation of the insert relative to the body is constrained when the insert is engaged with the locking recess.

2. The chainring of claim 1, wherein the insert includes a flange configured to interlock with the locking recess and a threaded tube portion connected to the flange that is configured to be received by the insert receiving aperture.

3. The chainring of claim 2, wherein the flange has a thickness that is less than or equal to the depth of the locking recess.

4. The chainring of claim 1, a fastener including a threaded portion that is configured to extend through the body from the first side of the body and engage the threaded tube portion of the insert.

5. The chainring of claim 1, wherein the body includes a plurality of aperture that extend from the first side to the second side of the body; at least two of the plurality of aperture are spaced at the same distance from a center point of the body.

6. The chainring of claim 1, wherein the body includes a central though opening and a plurality of tabs that extend inwardly from a periphery ring portion of the body.

7. The chainring of claim 1, wherein the insert receiving aperture is located on a tab that extends inwardly from a periphery ring portion of the body.

8. The chainring of claim 1, wherein the insert receiving aperture includes a circular cross sectional profile.

9. The chainring of claim 1, wherein the locking recess includes a non-circular periphery profile.

10. The chainring of claim 9, wherein the periphery profile of the locking recess is oval.

11. The chainring of claim 9, wherein the periphery profile of the locking recess includes flats.

12. The chainring of claim 1, wherein the body has a circular periphery.

13. The chainring of claim 1, wherein the insert receiving aperture is center in the locking recess.

14. The chain ring of claim 1, wherein the body includes an aluminum construction and the insert include a steel construction.

15. A chainring comprising:
a body including a ring shaped body portion including first side and an opposed second side, and a plurality of tabs that extend inwardly.
wherein each tab includes a locking recess that include a through insert receiving aperture in the locking recess, wherein the locking recess includes a non-circular periphery profile.

16. A chainring of claim 15, further comprising an insert configured to be received within at least a portion of the locking recess such that the rotation of the insert relative to the body is constrained when the insert is engaged with the locking recess.

17. The chainring of claim 16, wherein the insert include a flange configured to interlock with the locking recess and a threaded tube portion connected to the flange that is configured to be received by the insert receiving aperture.

18. A method of installing a chainring:
engaging a flange of a threaded insert with a recess in the body;
aligning the threaded insert with an aperture in a spider of a crank; and
inserting a threaded bolt through the aperture in the spider and engaging the threads on the bolt with the thread of the threaded insert.

20. The method of claim 18, wherein the step of engaging the threads on the both with the threads of the threaded insert requires the use of only a single hex tool.
